(19) United States
(12) Patent Application Publication
(10) Pub. No.: US 2002/0106115 A1
(43) Pub. Date: Aug. 8, 2002

(54) SYSTEM FOR ACQUIRING THREE-DIMENSIONAL FINGERPRINTS AND METHOD OF ACQUISITION

(76) Inventors: HENRI RAJBENBACH, BRUSSELS (BE); STEPHANE SAMOUILHAN, PARIS (FR); JEAN-PIERRE HUIGNARD, PARIS (FR)

Correspondence Address: OBLON SPIVAK MCCLELLAND MAIER & NEUSTADT, 1755 JEFFERSON DAVIS HIGHWAY, FOURTH FLOOR, ARLINGTON, VA, 22202

(21) Appl. No.: 09/077,308

(22) PCT Filed: Oct. 6, 1997
(86) PCT No.: PCT/FR97/01779

(30) Foreign Application Priority Data
Oct. 4, 1996 (FR) 96 12128

(51) Int. Cl. G06K 9/00

(52) U.S. Cl. 382/126

(57) ABSTRACT

The invention concerns a system for acquiring three-dimensional fingerprints, characterised in that it comprises: a medium (1) for receiving at least the object whose print is to be taken; optical image recording means (2); means for optical imaging (3) of the surface of the finger on the recording means. This system is applicable for acquiring fingerprints. It comprises various means for immobilising the hand.

Syst\acute{e}me d'acquisition d'empreintes en relief, caractérisé en ce qu'il comprend: un support (1) destiné à recevoir au moins l'objet dont on doit relever l'empreinte; des moyens d'enregistrement optique d'image (2); des moyens optiques d'magerie (3) de la face du doigt sur les moyens d'enregistrement Ce systéme est applicable à l'acquisition d'empreintes digitales. Il comporte différents moyens pour caler la main.

The invention relates to a system for acquiring relief prints and more particularly to a system for acquiring biometric prints such as fingerprints.

The invention is therefore in the field of the optical acquisition of fingerprints and its subject is a device for acquiring one or more prints, with no contact of the inside face of the finger on the acquisition device. This absence of contact allows deformation-free acquisition. The applications relate to the storing of prints, identification and authentication/validation.

Devices for acquiring fingerprints are conventionally of two types:

1) Inking pads: the person places his finger on an inking pad and then applies it to a sheet of paper so as to transfer the image of the ridges and furrows onto a paper support.

2) Acquisition by camera: these devices use the principle of the frustrated total internal reflection of a light wave illuminating an optical lens such as is described in the documents referenced (1) and (2) at the end of the description. The person applies his finger to an optical prism consisting of a block of glass. The points in contact (the ridges of the print) perturb the coefficient of reflection by perturbing the index in the vicinity of the interface lens. The image of the lens is transmitted to a camera (generally a CCD video camera) which thus records the fingerprint.

The main drawbacks of these devices are the quality, reliability and repeatability of the acquisition. This is because it is difficult to control the pressure exerted by a person on the paper or the prism. This results in large deformations of the image of the print. This deformation constitutes a major problem for identification operations (searching for a person in a database by print recognition) and authentication (checking of the bearer of a card, for example) such as is described in the documents referenced 3,4 and 5 at the end of the description.

To solve these problems, the invention relates to a device for acquiring fingerprints with no physical contact of the inside of the finger on the acquisition device. Acquisition will therefore be carried out in a totally passive phase of the person. The device of the invention therefore solves the problem of image distortions in the acquisition phase.

The invention therefore relates to a system for acquiring fingerprints, characterized in that it comprises:

a support intended to receive at least one finger whose prints are to be captured;

optical image recording means;

optical means for imaging the face of the finger on the recording means.

The various means of this system are described in the claims and, in particular, provision is made for the light illuminating the zone of the support which is intended to receive the finger or fingers to be polarized and for the system to comprise a polarization analyser situated between the support and the recording means; the analyser being oriented in such a way that its direction of polarization is parallel or perpendicular to the direction of polarization of the illuminating light.

The invention also relates to a process for acquiring fingerprints characterized in that:

a layer of a material containing metal is deposited on the surface of the finger whose print it is desired to capture;

the said surface is illuminated with a polarized illuminating light;

the said illuminated surface is imaged on the recording means by way of a polarization analyser whose direction of polarization is parallel or perpendicular to the direction of polarization of the illuminating light.

The various subjects and characteristics of the invention will emerge more clearly in the description which follows and in the appended figures which represent:

FIG. 1, a general example of the implementation of the system of the invention;

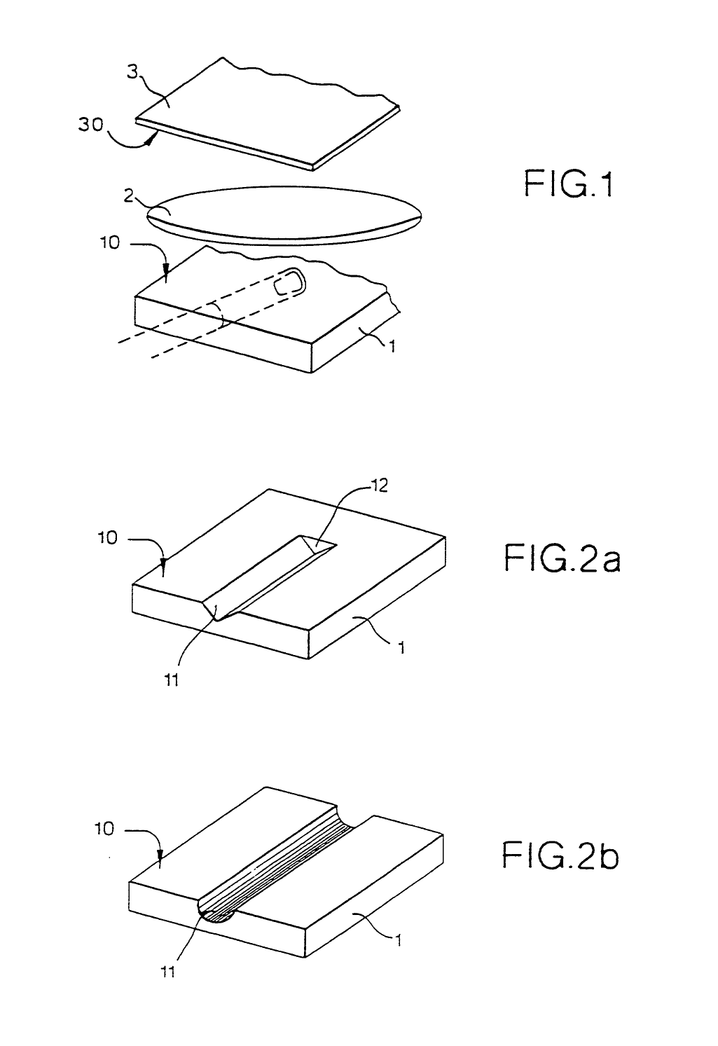

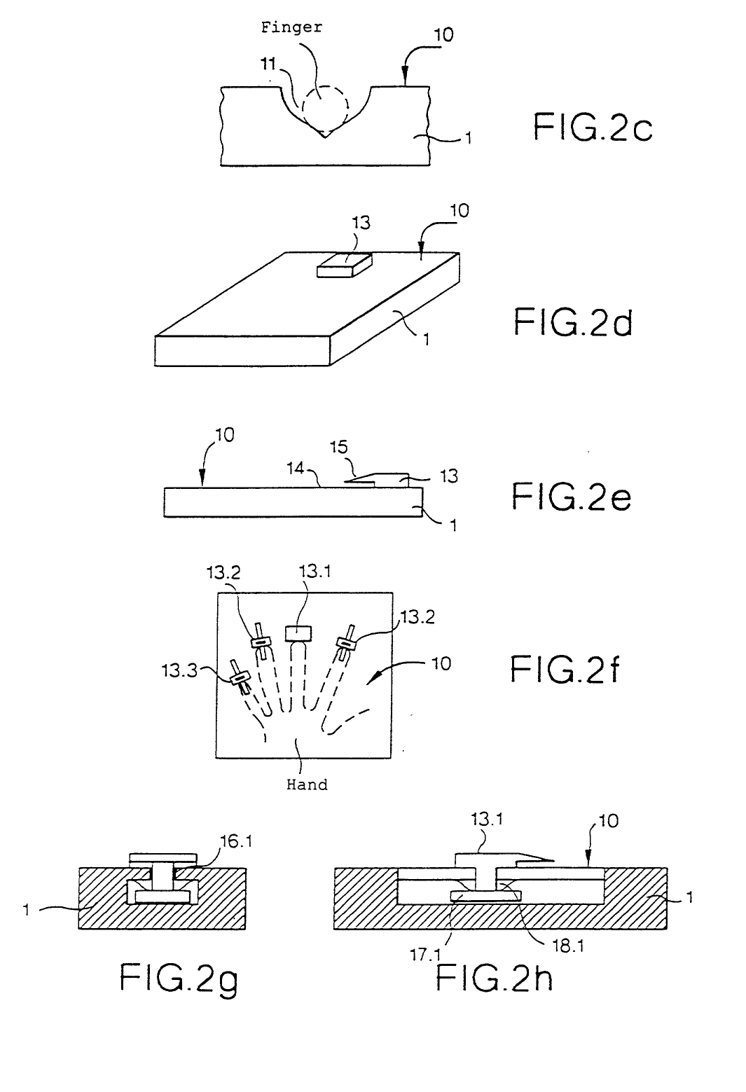

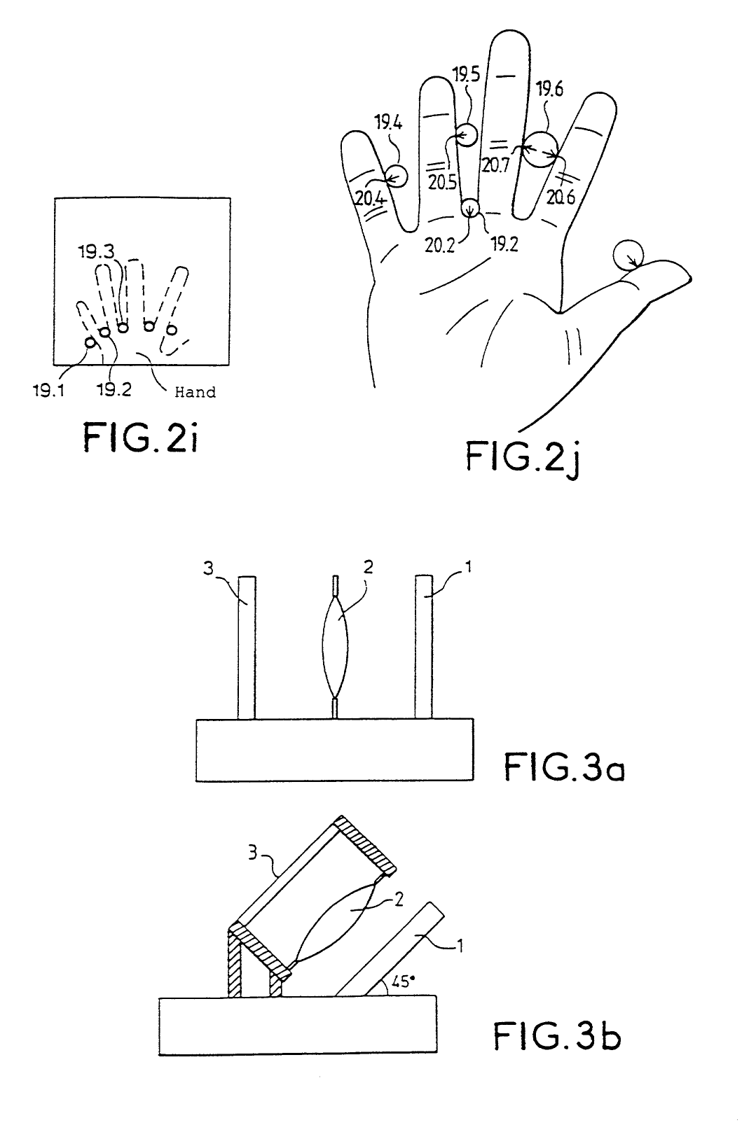

FIGS. 2a to 2j, various embodiments of the support making it possible to deposit one or more fingers whose prints it is desired to acquire;

FIGS. 3a and 3b, arrangements of the system with the support plate in a vertical position and oblique position;

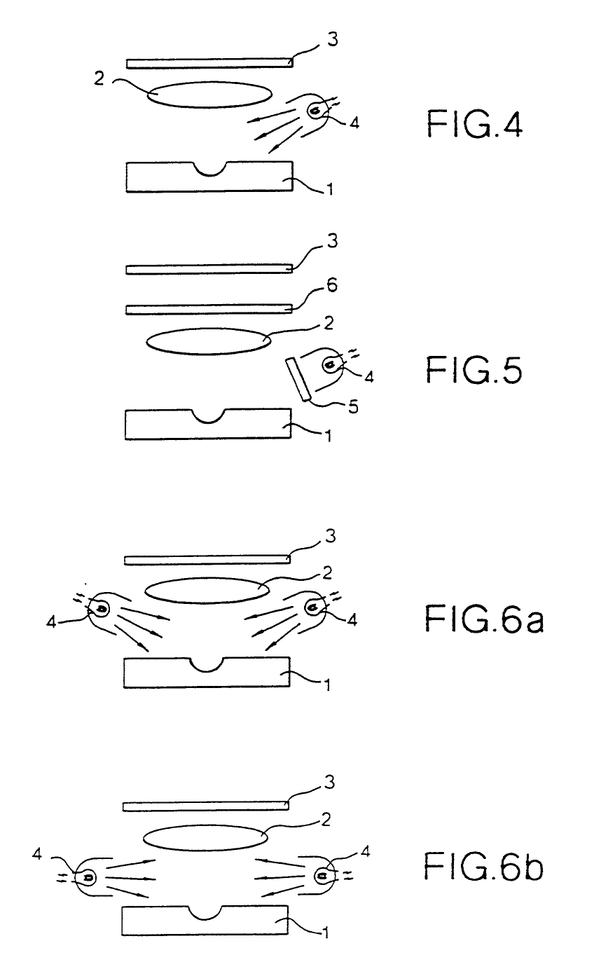

FIG. 4, the system according to the invention with artificial illumination;

FIG. 5, the system according to the invention designed to record prints which have previously been coated with a metallic layer;

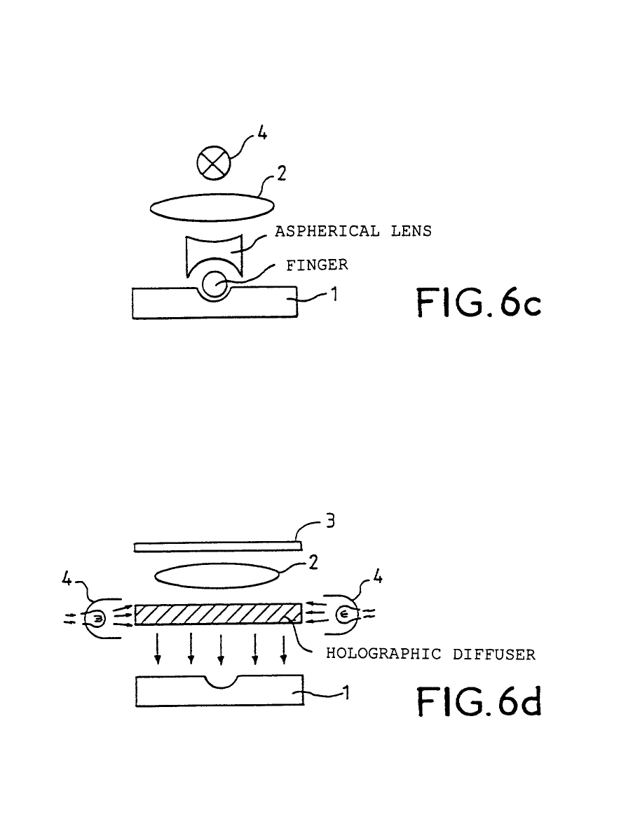

FIGS. 6a to 6d, arrangements of the source of illumination;

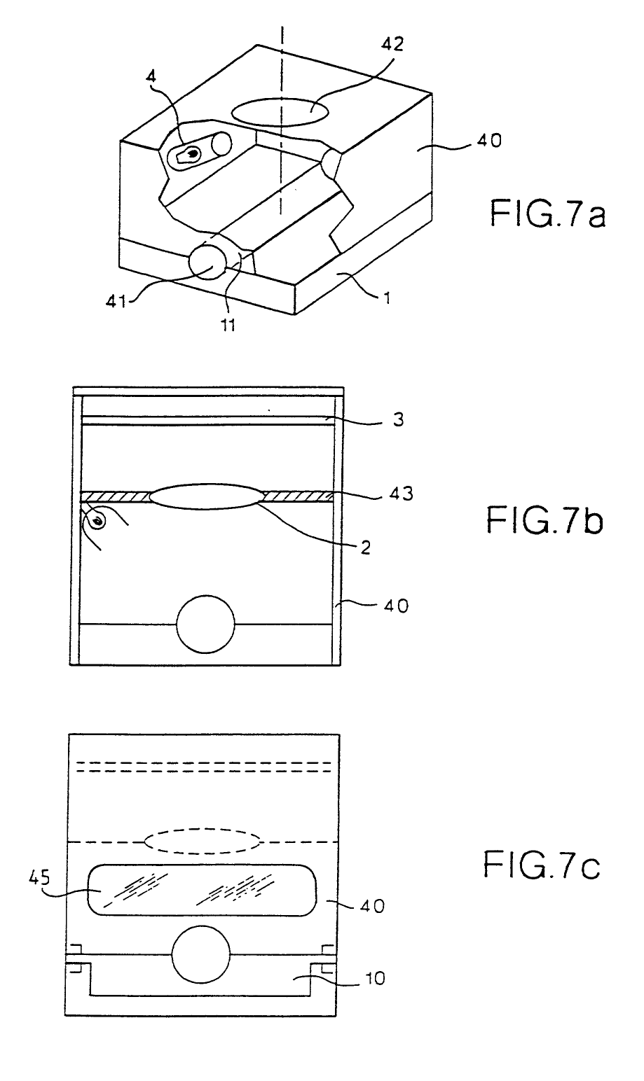

FIGS. 7a to 7c, the system according to the invention mounted in a casing;

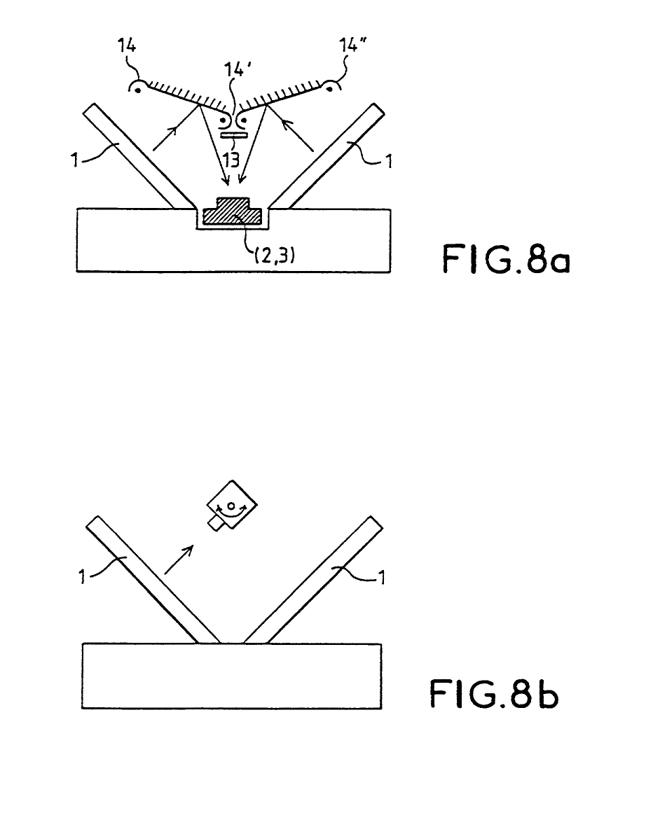

FIGS. 8a and 8b, a variant embodiment of the system according to the invention.

Referring to FIG. 1, a description will firstly be given of a simplified embodiment of the system of the invention.

This system comprises a support 1, made for example in the form of a plate, designed to receive the finger or fingers whose fingerprints are to be captured. According to FIG. 1, the face 10 of the support 1 is intended to receive the back of the finger, the fingerprints to be captured being directed upwards. An imaging device, represented by a lens 2, makes it possible to image that face of the finger bearing the fingerprints on a recording means 3.

The fingerprint acquisition device is therefore a contactless device which allows deformation-free acquisition of the prints.

The finger or fingers whose prints are to be captured must be located correctly under the imaging device. FIGS. 2a to 2g therefore provide various embodiments of the support 1.

According to FIG. 2a, the support made in the form of a plate 1, comprises, in its face 10, a groove 11. This groove restrains the location of the finger laterally with respect to the axis of the finger. To position the finger axially provision may be made to limit the length of the groove so that the end 12 of the groove corresponds to the end of the finger. The depth of the groove will be designed, preferably, in such a way that only the nail presses very lightly on the end 12. The end of the finger will thus suffer no deformation which would induce deformations of the print.

According to FIG. 2b, the groove 11 is a channel with the dimension (diameter) of the finger. The finger is therefore wedged laterally in this channel.

According to FIG. 2c, the walls of the channel are reflective. Moreover, the shape of the channel has a shape such that, especially in its upper part, it can reflect the light coming from the lateral walls of the finger towards the imaging device. It is thus possible to acquire a more complete image of the print. The bottom of the channel thus has a suitable shape for wedging the finger while the upper walls of the channel have a curvature allowing reflection of light from the finger towards the imaging device 2.

According to FIG. 2d, on its face 10 the support plate 1 comprises one stop 13 per finger which it is to receive. The end of a finger is pressed on this stop thereby making it possible to position the finger correctly. However, if this stop is such that the end of the finger presses thereon, the print may be deformed.

According to FIG. 2e, the stop 13 comprises a space 14 into which the nail of the finger may be slipped. Moreover, the end 15 of the stop is tapered so that this end lodges between the nail and the finger. In this way, the print will not be deformed whatever the pressure of the finger on the stop.

In the case where the system makes it possible to capture the prints from four fingers of a hand, the four fingers must be correctly positioned and all be abutted against the face 10 of the plate 1. According to FIG. 2f, a stop 13.1 enables the middle finger to be held against the face 10. For the other fingers, stops 13.2, 13.3 and 13.4 are provided which can slide in grooves 16.2, 16.3, 16.4. These stops are similar to the stop 13 of FIG. 2e and by adjusting the stops it is possible to adapt them to various lengths of fingers. As represented in FIGS. 2g and 2h, the system for adjusting a stop 13.1 comprises a T-shaped groove. The stop comprises a wide part 17.1 placed in the wide part of the T-shaped groove. A spring 18.1 abuts the groove 13.1 against the face 10 of the support 1. Along the groove, the face 10 is striated so as to brake the movement of the stop.

FIG. 2i represents a system for wedging the fingers according to which stops 19.1, 19.2, 19.3 etc. are provided on the support plate and are intended to sit between the fingers when the hand is laid on the plate 1. The stops can be axially adjustable in a manner similar to the stops of FIG. 2f.

FIG. 2j represents a system of stops comprising a stop 19.2 which serves to wedge the hand axially between two fingers. The other stops 19.4 to 19.6 serve to wedge the fingers laterally. In order for the hand to be properly placed, the patient must press the sides of the fingers against these stops. The stop 19.6 can be common to two fingers (the forefinger and the middle finger for example).

According to a variant embodiment, the stops can be provided with electrical or mechanical contacts 20.2 to 20.7 (feelers) placed in the zones of contact with the fingers. They are symbolized by arrows in FIG. 2j. When the hand is suitably placed, the contacts are actuated by the pressure of the fingers and enable the system to operate.

FIG. 3a represents an arrangement of the support 1 oriented vertically with respect to a horizontal base 20. The lens 2 and the recording means are then likewise arranged vertically. This arrangement is more ergonomic for laying the hand in position against the support 1.

FIG. 3b represents a variant of FIG. 3a in which the support is inclined with respect to the horizontal (30 to 60° for example). The hand rests in a natural manner on the support while being retained thereon on account of the frictional rubbing on the support, the optical system 2, 3 is then likewise inclined so as to be substantially normal to the plane of the support.

FIG. 4 represents a system in which a light source 4 is provided which illuminates the zone 11 of the support 1 which is intended to receive a finger.

According to FIG. 5, between the light source 4 and the support 1 there is a polarizer 5 which makes it possible to illuminate the zone 11 with the aid of a polarized light. Between the support 1 and the recording means 3 there is then a polarization analyser 6 oriented in a direction parallel to the direction of polarization of the light transmitted to the zone 11.

Such an arrangement is beneficial in the case where there is provision to deposit on the finger a layer of a product containing a metallic material. This product is deposited in such a way that only the ridges of the prints retain the metallic product while the troughs of the furrows retain none. It is known to those skilled in the art that scattering or reflection on a metallic surface occurs with conservation of the direction of polarization.

Accordingly, if the analyser 6 is oriented in the same direction as the polarizer 5, only the image of the ridges of the print will be transmitted by the analyser, thus solving the problem of contrast. Alternatively, if the analyser 6 is oriented in the direction at 90° to the direction of the polarizer 5, only the image of the furrows will reach the sensitive surface of the picture-taking device. A device has thus been produced which discriminates between ridges and furrows by polarization.

The analyser 6 has been represented between the lens 2 and the recording means 3, but it can be situated between the support 1 and the lens 2.

The light source 4 can be an incandescent lamp, a photographic flash, a halogen lamp or a laser source.

In the case of a semiconductor laser source emitting polarized light, the polarizer 5 is not necessary. Moreover, the laser source can be a laser emitting in the near infrared.

According to FIG. 6a, several light sources may be provided and in particular the light source may be annular so as to illuminate the finger at various angles.

Finally, according to FIG. 6b, the light source or sources may be placed in such a way as to illuminate the finger at grazing or near-grazing incidence so as to display the reliefs of the fingerprint more efficiently.

FIG. 6c represents a system in which an aspherical lens is provided which enables the image of the sides of the finger to be transmitted to the recording support.

FIG. 6d provides for the lighting system to have a holographic diffuser which receives the light through its rim and scatters it towards the finger.

By using a light source, there is benefit in hiding the finger whose print it is desired to capture from exterior illumination so that the recording means receive constant illumination. FIG. 7a represents a casing 40 which contains the support 1 together with its means for wedging at least one finger, such as the channel 11, as well as the light source 4. At least one hole 41 is provided in a wall of the casing to allow the passage of at least one finger and the movement thereof in the channel 11. Another hole 42 situated vertically in line with the channel 11 will enable the light reflected by the finger to be transmitted to the imaging device (lens 2) and to the recording means 3. In the case of FIG. 7a, the imaging device and the recording means could be:

a conventional photographic apparatus;

a digital-disc (CD) photographic apparatus;

a video camera.

Such an apparatus will then be abutted via its objective against the hole 42.

According to a variant embodiment represented in FIG. 7b, the support 1, the light source 4, the imaging device 2 and the recording means are mounted in the casing 40. The latter possesses the hole 41 for the passage of at least one finger. The recording means 3 are isolated from direct illumination from the source 4 by an internal wall 43 in which the lens 2 is mounted.

According to FIG. 7c, there is provision for the support plate 1 to be mounted in the casing 40 in the manner of a drawer. This makes it possible to provide supports 1 which can be interchanged depending on the size of the hands.

In FIGS. 7a to 7c only one hole for the passage of a finger has been represented but several holes may be provided for several fingers or a hole of elongate shape for the passage of several fingers or for the whole hand. Moreover, to overcome the apprehension of having to introduce one or more fingers into holes in a box, there is provision for all or part of the walls of the casing 40 to be transparent. For example, as represented in FIG. 7c, a window 45 will be provided making it possible to see inside the casing.

In the foregoing, the imaging device 2 was described in the form of a lens but it can be produced in the form:

of a macrophotographic objective;

of a macrophotographic objective associated with an aspherical lens adapted to the non-planar shape of the finger, for example a plano-concave lens. The use of such a lens allows the acquisition of a larger print area, in particular the edges of fingers. These edges of fingers are important when characteristics of the prints need to be extracted, for example the Galton number.

The metallic material used in conjunction with FIG. 5 can consist of a metallic powder (silver, zinc, copper etc.) diluted in a solvent (alcohol, acetone, water etc.) . This liquid can impregnate a pad of the inking pad on which the finger will be laid, or be used in a sprayer to spray the surface of the finger.

In the case when the device allows the simultaneous acquisition of prints from several fingers, the support 1 is adapted as described earlier; the casing comprises several holes 41 or one hole 41 of elongate shape so as to be able to slip several fingers into the casing; also the field covered by the imaging device 2 will be adapted to the number of prints to be acquired.

The recording means 3 can be a photographic support such as a photographic negative. They may also be photodetectors. In this case, the photodetectors are preferably laid out as a matrix array. Electronic circuits are associated therewith for reading the signals detected. CCD circuits available on the market will preferably be utilized for the production of such detectors.

According to a variant embodiment, the recording means may be an array sensor produced from CMOS circuits. With each photodetector there is associated a local processing circuit possessing connections with the neighbouring circuits in order to carry out this processing.

This processing consists in particular in enhancing the contrast of a photodetector with respect to the neighbouring photodetectors, and this will make it possible to obtain a contrasted image of the print. For example, when the photodetection current of a first photodetector is greater by a specified percentage than the photodetection currents of second neighbouring photodetectors, the system will allocate the value 1 to the first photodetector and the value 0 to the second photodetectors.

Such CMOS circuits may be produced as described in the document referenced 6 at the end of the description.

A detector with artificial retina is likewise described in the document referenced 7.

The processing of the image acquired may also be a digital processing. In order, in particular, to enhance the contrast, a digital filter of the following type may be used:

$$\begin{matrix}- 1 & - 1 & - 1 & - 1 & - 1 \\ - 1 & 1 & 1 & 1 & - 1 \\ - 1 & 1 & 9 & 1 & - 1 \\ - 1 & 1 & 1 & 1 & - 1 \\ - 1 & - 1 & - 1 & - 1 & - 1\end{matrix}$$

This filter can be programmed at will in order to modify the contrast.

Whatever type of recording means is used, the resolution of these recording means shall possibly be 128×128 (in a matrix array) for a print area to be acquired of 3 to 4 cm², but it will be difficult to have a lower resolution.

FIG. 8a represents an apparatus for acquiring fingerprints on the two hands of an individual, the latter entering his two hands into the apparatus. This apparatus comprises two supports 1 and 1′ each similar to that of FIG. 3b but inclined in opposite directions. The two supports are illuminated by one or more light sources 4. Above each support a mirror 6, 6′ returns the light reflected by the hands to a zone situated between the two supports. A picture-taking system (2, 3) such as a camera or a photographic apparatus is situated in this zone.

The light source or sources may take various forms and be placed at various locations. According to the example of FIG. 8a, light sources 4, 4′, 4″ are placed on either side of the mirrors. These sources possess reflectors 14, 14′, 14″ for directing the light towards the supports and possibly masks such as 13 for preventing these sources from illuminating the picture-taking system directly.

The two mirrors 6, 6′ are inclined symmetrically with respect to the axis of the system so as to reflect the light along this axis towards the picture-taking system.

The picture-taking system is designed so as to photograph the two supports (the two hands) simultaneously or in succession. In the case of the taking of successive pictures, the changing of the recording support 3 (its advance in the case of a camera or a photographic apparatus) will be carried out automatically.

FIG. 8b represents an apparatus in which in place of the mirrors 6 and 6′ is placed the picture-taking system (2, 3). This system is then mounted on a support which can be oriented so as to be directed at will towards one or other of the supports 1, 1′.

In the foregoing, the acquisition of fingerprints has been described but the system of the invention would allow the acquisition of any biometric print, such as the palm of the hand. It would also allow the identification of an object in relief of all kinds such as coins, etc.

The system of the invention has the following advantages:

deformation-free acquisition of fingerprints, since there is no contact of the inside face of the finger on the acquisition device;

possibility of incorporating a recognition module into the acquisition device. Thus, the absence of deformation in the acquisition phase permits the use of an electronic module for comparing the print acquired with one or more prints placed in memory in the device. This is particularly beneficial in the case of a detector of retina type, since the CMOS type technology makes it possible to incorporate image processing and computation functions directly at sensor level.

References

(1) A. Shimizu and M. Hase, “Entry method of fingerprint image using prism”, Trans. Inst.

Electronic. Comm. Engineers Japan, Part D, J67D (5), 627 (1984).

(2) L. A. Gerhardt, J. B. Attili, D. H. Crockett and A. M. Resler, “Fingerprint imagery using frustrated total internal reflection”, in Proc. 1986 Int. Carnahan Conf. on Security Technology, 251 (1986).

(3) S. Igaki, S. Eguchi, F. Yamagishi, H. Ikeda and T. Inagaki, “Real-time fingerprint sensor using a hologram”, Appl. Opt. 31, 1794-1802, (1992).

(4) Jacques Rodolfo, Henri Rajbenbach, Jean-Pierre Huignard, Performance of a Photorefractive Joint Transform Correlator for Fingerprint Identification, Opt. Eng., 34, 1166 (1994).

(5) H. Rajbenbach, Christophe Touret, J. P. Huignard, “Fingerprint database search by optical correlation”, in Optical Pattern Recognition VII, David P. Casasent, Tien-Hsin Chao, Editors, Proc. SPIE 2752, 214-223 (1996).

(6) Carver Mead, “Analog VLSI and Neural System”, Editors: ADDISON-WESLEY, 1989, Chapter 15 (Silicon Retina), pp. 257-278.

(7) T. Bernard, B. Zavidaique, F. Devos, IEEE Journal Solid State, 38, 789 (1993).

1. System for acquiring relief prints, characterized in that it comprises:
a support (1) intended to receive at least the object whose print is to be captured;
optical image recording means (2);
optical means (3) for imaging the face of the finger on the recording means.

2. System according to claim 1, characterized in that the support is a plate comprising means for wedging the finger laterally and axially (11 ,12, 13).

3. System according to claim 2, characterized in that the wedging means comprise at least one groove (11).

4. System according to claim 2, characterized in that the plate comprises a channel (11).

5. System according to claim 4, characterized in that the surface of the channel is reflective.

6. System according to claim 2, characterized in that the wedging means comprise a stop intended to position the end of a finger (12, 13).

7. System according to claim 6, characterized in that the stop (13) comprises a groove (14) intended to receive the end of a fingernail.

8. System according to claim 2, characterized in that the wedging means comprise stops (19) intended to be situated between the fingers.

9. System according to claim 8, characterized in that the stops comprise electrical or mechanical contacts for detecting the contact of the fingers on the stops.

10. System according to claim 2, characterized in that the support plate is oriented vertically or obliquely.

11. System according to claim 2, characterized in that the support (4) is interchangeable.

12. System according to claim 2, characterized in that the wedging means allow the wedging of four or five fingers of the hand.

13. System according to claim 12, characterized in that the wedging means allow the wedging of four or five fingers of two hands.

14. System according to claim 1, characterized in that the recording and imaging means are situated on an axis perpendicular to the plane of the support.

15. System according to claim 1, characterized in that it comprises a source of illumination which illuminates a zone of the support which is intended to receive the finger or fingers.

16. System according to claim 15, characterized in that the source of illumination is a photographic flash lamp, a halogen lamp or a laser source.

17. System according to claim 15, characterized in that the source of illumination is annular.

18. System according to claim 15, characterized in that the source of illumination is intended to illuminate the surface of the finger with grazing light.

19. System according to claim 15, characterized in that it comprises a holographic illumination device.

20. System according to claim 1, characterized in that the recording means comprise a surface of a photographic negative.

21. System according to claim 1, characterized in that the recording means comprise an array of photodetectors.

22. System according to claim 20, characterized in that the recording means comprise an electrical processing circuit associated with each photodetector of the array.

23. System according to either one of claims 1 or 15, characterized in that the imaging means and the recording means are produced with the aid of a conventional photographic apparatus, a digital-disc photographic apparatus or a video camera.

24. System according to claim 15, characterized in that the source of illumination and the support are contained in a casing comprising an opening for the insertion of at least one finger and an opening for transmitting light to the imaging system.

25. System according to claim 15, characterized in that the source of illumination and the recording means are contained in a casing comprising an opening for the insertion of at least one finger.

26. System according to one of claims 24 or 25, characterized in that the support takes the form of a plate and in that the casing comprises glideways in which this plate glides.

27. System according to claim 15, characterized in that the light illuminating the zone of the support which is intended to receive the finger or fingers is polarized and in that the system comprises a polarization analyser (6) situated between the support and the recording means; the analyser being oriented in such a way that its direction of polarization is parallel or perpendicular to the direction of polarization of the illuminating light.

28. System according to claim 26, characterized in that it comprises a polarizer (5) situated between the source and the zone of the support.

29. Process for acquiring fingerprints characterized in that:
a layer of a material containing metal is deposited on the surface of the finger whose print it is desired to capture;
the said surface is illuminated with a polarized illuminating light;
the said illuminated surface is imaged on the recording means by way of a polarization analyser whose direction of polarization is parallel or perpendicular to the direction of polarization of the illuminating light.

30. Process according to claim 29, characterized in that the layer of material containing metal is deposited:
either by applying the finger to a pad;
or by rubbing the finger on a material containing metal;
or by spraying the said material;
or by applying the said material with a brush.

31. Process according to claim 29, characterized in that the material containing metal is produced from a powder of a metal such as silver, zinc, copper; it being possible to dilute this powder in a solvent.
